(19) United States
(12) Patent Application Publication
(10) Pub. No.: US 2025/0253436 A1
(43) Pub. Date: Aug. 7, 2025

(54) SUPPLY MODE

(71) Applicant: MAHLE International GmbH, Stuttgart (DE)

(72) Inventors: Ralf Zink, Stuttgart (DE); Kai Saupe, Boeblingen (DE); Markus Lang, Loechgau (DE)

(21) Appl. No.: 19/043,463

(22) Filed: Feb. 1, 2025

(30) Foreign Application Priority Data
Feb. 1, 2024 (DE) 102024102838.6

(51) Int. Cl. H01M 10/6567; B01D 17/02; B01D 36/00; H01M 10/613; H01M 10/625

(52) U.S. Cl. CPC H01M 10/6567; B01D 17/02; B01D 36/003; H01M 10/613; H01M 10/625; H01M 2220/20

(57) ABSTRACT

A supply module for a fluid circuit through which a cooling fluid is flowable, for immersion cooling of a battery of a vehicle, may include a fluid equalization tank for equalizing a change in volume of the cooling fluid in the fluid circuit, an air equalization tank for absorbing air, and a common housing for the fluid equalization tank and the air equalization tank. The fluid equalization tank may be connected to the air equalization tank in an air-conducting manner to equalize pressure differences caused by different fill levels of the cooling fluid in the fluid equalization tank. The fluid equalization tank and the air equalization tank may be formed in the housing and may be delimited outwardly by the housing.

### CROSS-REFERENCE TO RELATED APPLICATIONS

This application claims priority to German Patent Application No. DE102024102838.6, filed on Feb. 1, 2024, the contents of which is hereby incorporated by reference in its entirety.

### TECHNICAL FIELD

The invention relates to a supply module for a fluid circuit through which a cooling fluid can flow, for the immersion cooling of a battery of a vehicle.

### BACKGROUND

A battery of a vehicle can be immersion-cooled in a fluid circuit with a cooling fluid such as oil, for example. In this case, the cooling fluid in the fluid circuit must be temperature-controlled, dried, and filtered. Furthermore, the fill level of the cooling fluid should be compensated for due to a temperature- and/or age-related change in volume. To perform these functions, the fluid circuit usually comprises a fluid equalization tank, an air equalization tank, a heat exchanger, a dehumidifier, a fluid filter, and a fluid pump. The individual elements of the fluid circuit must be fluidically connected to each other via hoses in a complex process. This results in several hydraulic interfaces that need to be tested and maintained. Furthermore, the fluid circuit requires a lot of space.

### SUMMARY

The task of the invention is therefore to provide a supply module in which the disadvantages described are overcome.

According to the invention, this task is solved by the subject matter of the independent claim(s). Advantageous embodiments are the subject matter of the dependent claim(s).

The present invention is based on the general idea of integrating a fluid pump, a plate heat exchanger, a fluid equalization tank, an air equalization tank, and a dehumidifier in a module.

The supply module according to the invention is provided and designed for a fluid circuit through which a cooling fluid can flow for the immersion cooling of a battery of a vehicle. The cooling fluid can be in particular a liquid such as oil. The supply module has a fluid equalization tank for equalizing a change in volume of the cooling fluid in the fluid circuit and an air equalization tank for absorbing air. The fluid equalization tank is connected to the air equalization tank in an air-conducting manner to equalize pressure differences caused by different fill levels of the cooling fluid in the fluid equalization tank. The supply module has a common housing for the fluid equalization tank and the air equalization tank. The fluid equalization tank and the air equalization tank are formed in the housing and delimited outwardly by the housing.

In the supply module according to the invention, the fluid equalization tank and the air equalization tank are in the common housing and are designed to save space. As a result, the supply module has a high level of integration and can be arranged in the fluid circuit to save space. Furthermore, the scope of assembly, maintenance and testing at the customer's site can also be reduced.

The fluid equalization tank can be formed by a first portion of the housing that delimits a first space for receiving the cooling fluid to the outside. The air equalization tank can be formed by a second portion of the housing that delimits a second space for receiving air to the outside. The sections of the housing can be formed in one piece on top of each other or can merge integrally into each other. In other words, the two sections can be inseparable from each other. The two chambers can be separated from each other fluidically within the housing. An air-conducting connection between the fluid equalization tank and the air equalization tank can be realized within the housing or directly in the housing, thereby reducing the space required for the supply module and the number of hydraulic interfaces compared to conventional solutions.

In one possible embodiment of the supply module, the housing can have an upper part and a lower part. The upper part and the lower part can be formed separately from each other and connected to each other in a fluid-tight manner. In particular, the upper part and the lower part can be welded to each other. The upper part and the lower part can together form the two sections of the housing described above. The air equalization tank can then be formed in sections in the upper part of the housing and the fluid equalization tank can be formed in sections in the upper part of the housing and in sections in the lower part of the housing. This embodiment of the housing can simplify the manufacturing of the housing or the fluid equalization tank and the air equalization tank.

In one possible embodiment of the supply module, the fluid equalization tank can be divided into a working chamber for receiving the cooling fluid and an overflow chamber for receiving the excess cooling fluid from the receiving chamber. The working chamber can be fluidically connected to the overflow chamber such that the cooling fluid can pass from the working chamber into the overflow chamber but cannot pass from the overflow chamber into the working chamber. The overflow chamber can be used to hold the excess cooling fluid that arises in the fluid circuit due to battery aging. The fluid equalization tank or the first space is fluidically connected to other elements of the supply module and/or the fluid circuit via the working chamber.

In one possible embodiment of the supply module, the supply module can have a fluid pump for conveying the cooling fluid in the fluid circuit. The fluid pump can be attached directly to the housing and fluidically connected to the fluid equalization tank. The fluid pump can be screwed to the housing, for example. In this embodiment of the supply module, the fluid pump can be arranged on the housing in a space-saving manner and the overall space requirement for the fluid pump in the fluid circuit can be reduced.

The fluid pump can have a spiral housing for receiving an impeller of the fluid pump. The spiral housing can be formed integrally with the housing or inseparably from the housing. In particular, the spiral housing of the fluid pump can be injection molded onto the housing. This allows a particularly compact design of the supply module.

An inlet of the spiral housing of the fluid pump can fluidically open directly or via a formed feed into the common housing of the fluid equalization tank. In other words, no other connecting elements—such as hoses or pipes—can be arranged between the inlet of the spiral housing and the housing. If the spiral housing is formed integrally or inseparably with the housing, the inlet of the spiral housing can be formed—for example, injection molded—around an associated outlet of the fluid equalization tank. With this embodiment, the number of hydraulic interfaces in the supply module can be reduced. Accordingly, the assembly and maintenance effort can also be reduced.

An outlet of the spiral housing of the fluid pump can be fluidically connected directly to an inlet of a heat exchanger that is directly attached to the housing. In other words, no further connecting elements, such as hoses or pipes, can be arranged between the outlet of the spiral housing and the heat exchanger. This embodiment can, in particular, reduce the number of hydraulic interfaces in the supply module and thus reduce the assembly and maintenance effort.

In one possible embodiment of the supply module, the supply module can have a heat exchanger for cooling the cooling fluid in the fluid circuit. In particular, the heat exchanger can be a plate heat exchanger. The heat exchanger can be attached directly to the housing and connected fluidically to the fluid equalization tank. For example, the heat exchanger can be screwed to the housing. As described in more detail below, the heat exchanger can be indirectly fluidically connected to the fluid equalization tank via the fluid pump described above. In this embodiment of the supply module, the heat exchanger can be arranged on the housing in a space-saving manner and the overall space requirement for the heat exchanger in the fluid circuit can be reduced.

In one possible embodiment of the supply module, the supply module can have a fluid filter for filtering the cooling fluid in the fluid circuit. The fluid filter can be arranged in or on the fluid equalization tank and be fluidically connected to the fluid equalization tank. If the supply module has a fluid pump, the fluid filter can be connected downstream of the fluid pump on the pressure side or upstream of the fluid pump on the suction side. This means that the fluid filter can be arranged in a particularly space-saving way and the number of hydraulic interfaces in the supply module can also be reduced. Accordingly, the assembly and maintenance effort can be reduced.

In one possible embodiment of the supply module, the supply module can have a dehumidifier for absorbing water contained in the cooling fluid. The dehumidifier can be arranged in or on the fluid equalization tank and be connected to the fluid equalization tank in a fluidic manner. If the supply module has a fluid pump, the dehumidifier of the fluid pump can be connected downstream on the pressure side or upstream on the suction side. In particular, the dehumidifier can absorb the water in the cooling fluid and thereby dry the cooling fluid. By arranging the dehumidifier in the fluid equalization tank, the supply module can be designed to save a lot of space. Furthermore, the number of hydraulic interfaces in the supply module and, accordingly, the installation and maintenance effort can be reduced.

As described above, the supply module may include further elements in addition to the fluid equalization tank and the air equalization tank. These elements may be fluidically connected to the fluid equalization tank and to each other. If the supply module has a fluid pump, for example, the fluid pump can be fluidically connected downstream of the fluid equalization tank. The other elements can then be fluidically connected upstream or downstream of the fluid pump. If the supply module has a heat exchanger, the heat exchanger can be fluidically connected downstream of the fluid equalization tank. If the supply module has a fluid pump and a heat exchanger, the fluid pump can be fluidically connected downstream of the fluid equalization tank and the heat exchanger can be fluidically connected downstream of the fluid pump. If the supply module has a dehumidifier and a fluid pump, the fluid pump can be fluidically connected downstream of the fluid equalization tank and the fluid filter of the fluid pump can be fluidically connected either upstream or downstream. If the supply module has a fluid filter and a fluid pump, the fluid pump can be fluidically connected downstream of the fluid equalization tank and the dehumidifier can be fluidically connected upstream or downstream of the fluid pump. If the supply module has a dehumidifier and a fluid filter, the dehumidifier can be fluidically connected upstream of the fluid filter.

In one possible embodiment of the supply module, the air equalization tank can have an air inlet leading from the outside into the air equalization tank and an air outlet leading from the air equalization tank to the outside. The supply module can then have an air dehumidifier and/or a valve that is fluidically connected downstream of the air inlet. Alternatively or additionally, the supply module can have a hydrocarbon separator and/or a valve that is fluidically connected upstream of the air outlet. The air inlet and the air outlet can be used to equalize the pressure differences in the air equalization tank.

Further important features and advantages of the invention are apparent from the dependent claims, from the drawings, and from the associated description of the figures with reference to the drawings.

It is understood that the above-mentioned features and those yet to be explained below can be used not only in the combination indicated in each case, but also in other combinations or on their own, without deviating from the scope of the present invention.

Preferred exemplary embodiments of the invention are shown in the drawings by way of example and will be explained in more detail in the following description, wherein identical reference signs refer to identical or similar or functionally identical elements.

### BRIEF DESCRIPTION OF THE DRAWINGS

It shows, schematically in each case:

FIG. 1 shows a view of a supply module according to the invention;

FIG. 2 shows a view of a fluid circuit with the supply module according to the invention.

### DETAILED DESCRIPTION

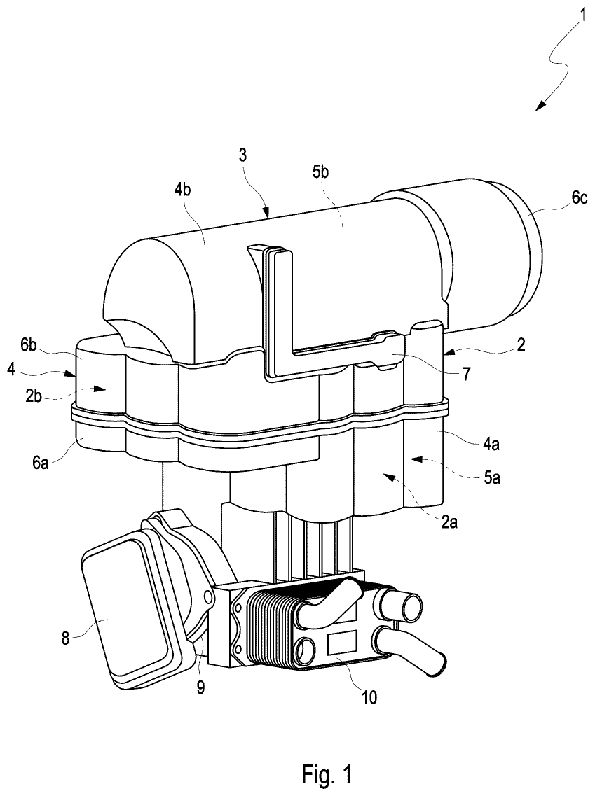

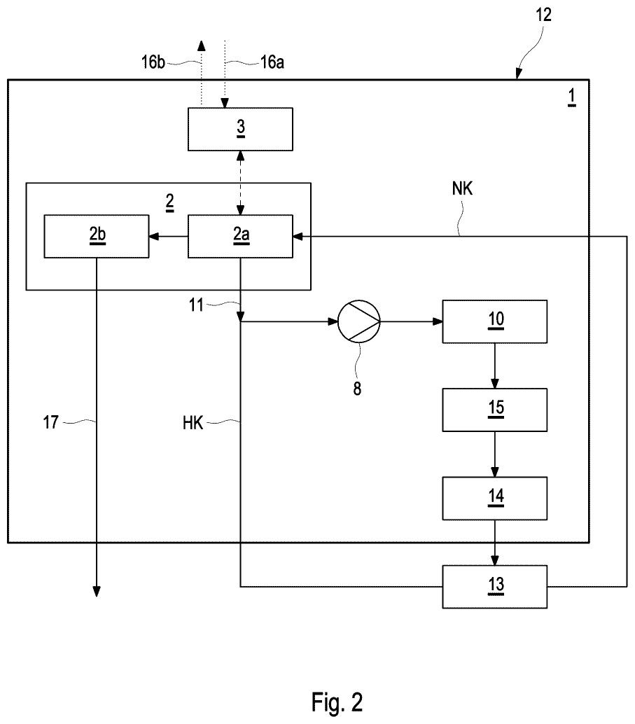

FIG. 1 shows a view of a supply module 1 according to the invention in a first embodiment. The supply module 1 is designed for a fluid circuit 12—see FIG. 2—through which a cooling fluid can flow, for the immersion cooling of a vehicle battery. In the first embodiment, supply module 1 comprises a fluid equalization tank 2 and an air equalization tank 3, which are formed in a common housing 4 of supply module 1.

The fluid equalization tank 2 is formed by a first section 4a of the housing 4, wherein the first section 4a delimits a first space 5a for receiving the cooling fluid to the outside. The fluid equalization tank 2 and the first space 5a are divided into a working chamber 2a and an overflow chamber 2b. The overflow chamber 2b is fluidically connected to the working chamber 2a such that the cooling fluid can flow from the working chamber 2a into the overflow chamber 2b but not back. The overflow chamber 2b can absorb the excess cooling fluid that arises due to battery aging in the fluid circuit 12—see FIG. 2. The fluid equalization tank 2 or the first space 5a is fluidically connected to other elements of the supply module 1 and/or the fluid circuit 12 via the working chamber 2a.

The air equalization tank 3 is formed by a second section 4b of the housing 4, wherein the section 4b delimits a second space 5b for receiving air to the outside. The two sections 4a and 4b of the housing 4 are integrally formed on one another. The air equalization tank 3 can be connected to the environment in an air-conducting manner via an air inlet 16a and an air outlet 16b—see FIG. 2. The supply module 1 can have an air dehumidifier for the air inlet 16a and/or a hydrocarbon separator for the air outlet 16b. The dehumidifier can be used to dry the air flowing in through the air inlet 16a and/or the hydrocarbon separator can be used to separate hydrocarbons from the air flowing out through the air outlet 16b. Furthermore, the supply module 1 can have a valve downstream of the air inlet 16a and/or a valve connected upstream of the air outlet 16b for closing and/or opening the air inlet 16a and the air outlet 16b.

The housing 4 also comprises a lower part 6a and an upper part 6b that are connected to each other in a fluid-tight manner, for example, welded. The fluid equalization tank 2 or the first space 5a is formed in sections in the lower part 6a and in sections in the upper part 6b. The air equalization tank 3 or the second space 5b is formed in the upper part 6b. Furthermore, the housing 4 comprises a cover 6c which closes the second space 5b at the upper part. The housing 4 can be formed from plastic, for example.

The fluid equalization tank 2 or the first space 5a and the air equalization tank 3 or the second space 5b are separated from one another in a fluid-tight manner within the housing 4 and are connected fluidically only via a line 7. The line 7 is formed on the housing 4 or is formed integrally or in one piece with the housing 4. Pressure differences that arise due to different fill levels of the cooling fluid in the fluid equalization tank 2 can be compensated with air from the air equalization tank 3 via the line 7. In addition, the working chamber 2a and the overflow chamber 2b are fluidically connected to each other via the line 7. This allows the excess cooling fluid to pass from the working chamber 2a into the overflow chamber 2b via line 7 before the excess cooling fluid flows into the second space 5b or into the air equalization tank 3. The excess cooling fluid can occur due to the aging of the battery 13 in the fluid circuit 12—see FIG. 2. Over time, the battery cells of the battery 13 expand and permanently displace the cooling fluid. This excess cooling fluid can then be stored in the overflow chamber 2b and drained as needed during servicing or removed from the fluid circuit 12.

Supply module I also comprises a fluid pump 8 that is directly attached to the housing 4. To do this, the fluid pump 8 can be screwed to the housing 4, for example. Alternatively, the fluid pump can have a spiral housing that is injection-molded onto the housing 4. The fluid pump 8 is fluidically connected to the fluid equalization tank 2 and to the working chamber 2a of the fluid equalization tank 2. A hydraulic interface 9 between the fluid pump 8 and the housing 4 can be sealed from the outside, for example, by means of an O-ring seal or a molded seal. Furthermore, the supply module 1 comprises a heat exchanger 10, which is directly attached to the housing 4. For this purpose, the heat exchanger 10 can be screwed to the housing 4, for example. In the exemplary embodiment shown, the heat exchanger 10 is a plate heat exchanger. Furthermore, the supply module 1 can have a dehumidifier and/or a fluid filter, which can be arranged inside the fluid equalization tank 2 or the first space 5a or the working chamber 2a or on the fluid equalization tank 2.

FIG. 2 shows a view of a fluid circuit 12 with the supply module 1 according to the invention. In addition to the supply module 1, the fluid circuit 12 also comprises an immersion-cooled battery 13 of a vehicle. The flow of the cooling fluid is indicated by solid arrows and the flow of air by dashed arrows. The cooling fluid may in particular be a cooling liquid such as oil.

Supply module 1 comprises the fluid equalization tank 2, the air equalization tank 3, the fluid pump 8, the heat exchanger 10, a fluid filter 14 and a dehumidifier 15. In the supply module 1, the fluid pump 8 is connected downstream of the fluid equalization tank 2 and is fluidically connected to the working chamber 2a of the fluid equalization tank 2 via a feed 11. Furthermore, the heat exchanger 10 of the fluid pump 8, the dehumidifier 15 of the heat exchanger 10 and the fluid filter 14 of the dehumidifier 15 are fluidically connected downstream. The dehumidifier 15 can alternatively be arranged in the fluid equalization tank 2 and fluidically connected upstream of it.

In the fluid circuit 12, the cooling fluid is pumped by the fluid pump 8. The cooling fluid flows in a main circuit HK via the fluid pump 8, the heat exchanger 10, the dehumidifier 15, the fluid filter 145, and the battery 13. If the volume of the cooling fluid in the main circuit HK changes, the cooling fluid can flow out of the main circuit HK into the working chamber 2a of the fluid equalization tank 2 via an auxiliary circuit NK or flow from the working chamber 2a into the main circuit HK via the feed 11.

The working chamber 2a is fluidically connected to the air equalization tank 3 so that the air in the air equalization tank 3 can equalize the pressure differences in the working chamber 2a. To do this, the air equalization tank 3 is connected to the environment—as already described above—via the air inlet 16a and the air outlet 16b so that air can flow between them. Furthermore, the working chamber 2a is fluidically connected to the overflow chamber 2b. As described above, the overflow chamber 2b can absorb the excess cooling fluid from the working chamber 2a. The excess cooling fluid can then be drained off through a drain 17 during servicing.

Various examples/embodiments are described herein for various apparatuses, systems, and/or methods. Numerous specific details are set forth to provide a thorough understanding of the overall structure, function, manufacture, and use of the examples/embodiments as described in the specification and illustrated in the accompanying drawings. It will be understood by those skilled in the art, however, that the examples/embodiments may be practiced without such specific details. In other instances, well-known operations, components, and elements have not been described in detail so as not to obscure the examples/embodiments described in the specification. Those of ordinary skill in the art will understand that the examples/embodiments described and illustrated herein are non-limiting examples, and thus it can be appreciated that the specific structural and functional details disclosed herein may be representative and do not necessarily limit the scope of the embodiments.

Reference throughout the specification to “examples, “in examples,” “with examples,” “various embodiments,” “with embodiments,” “in embodiments,” or “an embodiment,” or the like, means that a particular feature, structure, or characteristic described in connection with the example/embodiment is included in at least one embodiment. Thus, appearances of the phrases “examples, “in examples,” “with examples,” “in various embodiments,” “with embodiments,” “in embodiments,” or “an embodiment,” or the like, in places throughout the specification are not necessarily all referring to the same embodiment. Furthermore, the particular features, structures, or characteristics may be combined in any suitable manner in one or more examples/embodiments. Thus, the particular features, structures, or characteristics illustrated or described in connection with one embodiment/example may be combined, in whole or in part, with the features, structures, functions, and/or characteristics of one or more other embodiments/examples without limitation given that such combination is not illogical or non-functional. Moreover, many modifications may be made to adapt a particular situation or material to the teachings of the present disclosure without departing from the scope thereof.

It should be understood that references to a single element are not necessarily so limited and may include one or more of such element. Any directional references (e.g., plus, minus, upper, lower, upward, downward, left, right, leftward, rightward, top, bottom, above, below, vertical, horizontal, clockwise, and counterclockwise) are only used for identification purposes to aid the reader's understanding of the present disclosure, and do not create limitations, particularly as to the position, orientation, or use of examples/embodiments.

“One or more” includes a function being performed by one element, a function being performed by more than one element, e.g., in a distributed fashion, several functions being performed by one element, several functions being performed by several elements, or any combination of the above.

It will also be understood that, although the terms first, second, etc. are, in some instances, used herein to describe various elements, these elements should not be limited by these terms. These terms are only used to distinguish one element from another. For example, a first element could be termed a second element, and, similarly, a second element could be termed a first element, without departing from the scope of the various described embodiments. The first element and the second element are both elements, but they are not the same element.

The terminology used in the description of the various described embodiments herein is for the purpose of describing particular embodiments only and is not intended to be limiting. As used in the description of the various described embodiments and the appended claims, the singular forms “a”, “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

Joinder references (e.g., attached, coupled, connected, and the like) are to be construed broadly and may include intermediate members between a connection of elements, relative movement between elements, direct connections, indirect connections, fixed connections, movable connections, operative connections, indirect contact, and/or direct contact. As such, joinder references do not necessarily imply that two elements are directly connected/coupled and in fixed relation to each other. Connections of electrical components, if any, may include mechanical connections, electrical connections, wired connections, and/or wireless connections, among others. Uses of “e.g.” and “such as” in the specification are to be construed broadly and are used to provide non-limiting examples of embodiments of the disclosure, and the disclosure is not limited to such examples.

While processes, systems, and methods may be described herein in connection with one or more steps in a particular sequence, it should be understood that such methods may be practiced with the steps in a different order, with certain steps performed simultaneously, with additional steps, and/or with certain described steps omitted.

As used herein, the term “if” is, optionally, construed to mean “when” or “upon” or “in response to determining” or “in response to detecting,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event],” depending on the context.

All matter contained in the above description or shown in the accompanying drawings shall be interpreted as illustrative only and not limiting. Changes in detail or structure may be made without departing from the present disclosure.

1. A supply module for a fluid circuit through which a cooling fluid is flowable, for immersion cooling of a battery of a vehicle, comprising:
a fluid equalization tank for equalizing a change in volume of the cooling fluid in the fluid circuit;
an air equalization tank for absorbing air;
the fluid equalization tank connected to the air equalization tank in an air-conducting manner to equalize pressure differences caused by different fill levels of the cooling fluid in the fluid equalization tank;
a common housing for the fluid equalization tank and the air equalization tank; and
wherein the fluid equalization tank and the air equalization tank are formed in the housing and are delimited outwardly by the housing.

2. The supply module according to claim 1, wherein:
the fluid equalization tank is defined by a first section of the housing, which delimits a first space for receiving the cooling fluid to an outside;
the air equalization tank is defined by a second section of the housing, which delimits a second space for absorbing air to the outside; and
the first section and the second section of the housing merge integrally into each other.

3. The supply module according to claim 1, wherein:
the housing includes a lower part and an upper part formed separately from each other and connected to each other in a fluid-tight manner;
the fluid equalization tank is formed, in sections, in the lower part of the housing and, in sections, in the upper part of the housing; and
the air equalization tank is formed in the upper part.

4. The supply module according to claim 1, wherein:
the fluid equalization tank is divided into a working chamber for receiving the cooling fluid from the fluid circuit and an overflow chamber for receiving an excess of the cooling fluid from the working chamber; and
the working chamber is connected to the overflow chamber such that the cooling fluid is passable from the working chamber into the overflow chamber but the cooling fluid is not passable from the overflow chamber into the working chamber.

5. The supply module according to claim 1, further comprising a fluid pump for conveying the cooling fluid in the fluid circuit, wherein the fluid pump is attached directly to the housing and is fluidically connected to the fluid equalization tank.

6. The supply module according to claim 5, wherein:
the fluid pump includes an impeller and a spiral housing for accommodating the impeller; and
the spiral housing is integrally formed with the housing.

7. The supply module according to claim 6, wherein an inlet of the spiral housing of the fluid pump fluidically opens into the fluid equalization tank i) directly and/or ii) via a feed formed in the housing into the fluid equalization tank.

8. The supply module according to claim 1, further comprising a heat exchanger for cooling the cooling fluid in the fluid circuit, the heat exchanger attached directly to the housing and fluidically connected to the fluid equalization tank.

9. The supply module according to claim 1, further comprising a fluid filter for filtering the cooling fluid in the fluid circuit, the fluid filter arranged in and/or on the fluid equalization tank and fluidically connected to the fluid equalization tank.

10. The supply module according to claim 1, further comprising a dehumidifier for absorbing water contained in the cooling fluid, the dehumidifier arranged in and/or on the fluid equalization tank and fluidically connected to the fluid equalization tank.

11. The supply module according to claim 1, further comprising a fluid pump fluidically connected downstream of the fluid equalization tank.

12. The supply module according to claim 1, further comprising an air dehumidifier and a valve, wherein:
the air equalization tank includes:
an air inlet extending from an outside into the air equalization tank; and
an air outlet extending from the air equalization tank to the outside; and
the air dehumidifier and the valve are fluidically connected downstream of the air inlet.

13. The supply module according to claim 1, further comprising a hydrocarbon separator and a valve, wherein:
the air equalization tank includes:
an air inlet extending from an outside into the air equalization tank; and
an air outlet extending from the air equalization tank to the outside; and
the hydrocarbon separator and the valve are fluidically connected upstream of the air outlet.

14. The supply module according to claim 6, wherein an outlet of the spiral housing of the fluid pump is fluidically connected directly to an inlet of a heat exchanger attached directly to the housing.

15. The supply module according to claim 7, wherein an outlet of the spiral housing of the fluid pump is fluidically connected directly to an inlet of a heat exchanger attached directly to the housing.

16. The supply module according to claim 1, further comprising a heat exchanger fluidically connected downstream of the fluid equalization tank.

17. The supply module according to claim 1, further comprising:
a fluid pump fluidically connected downstream of the fluid equalization tank; and
a heat exchanger fluidically connected downstream of the fluid pump.

18. The supply module according to claim 1, further comprising:
a fluid pump fluidically connected downstream of the fluid equalization tank; and
a fluid filter fluidically connected upstream or downstream of the fluid pump.

19. The supply module according to claim 1, further comprising:
a fluid pump fluidically connected downstream of the fluid equalization tank; and
a dehumidifier fluidically connected upstream or downstream of the fluid pump.

20. The supply module according to claim 1, further comprising:
a fluid filter; and
a dehumidifier fluidically connected upstream of the fluid filter.
